(19) United States
(12) Patent Application Publication
(10) Pub. No.: US 2024/0015376 A1
(43) Pub. Date: Jan. 11, 2024

(54) INFRARED CAPTURE DEVICE

(71) Applicant: Raul GARCIA MARTIN, Madrid (ES)

(72) Inventor: Raul GARCIA MARTIN, Madrid (ES)

(21) Appl. No.: 18/195,515

(22) Filed: May 10, 2023

(30) Foreign Application Priority Data
Jul. 7, 2022 (ES) P202230619

(51) Int. Cl. H04N 23/20; H04N 23/51; H04N 7/015

(52) U.S. Cl. CPC H04N 23/20; H04N 23/51; H04N 7/015

(57) ABSTRACT

The high-definition or ultra-high-definition infrared capture device comprises a housing (1) with a socket (2) for connection to an electronic device and one or more cameras (4) configured for infrared capture. The device enables high definition to be achieved. It can be used as a complement to electronic devices, such as mobile phones, thereby increasing their usefulness.

### OBJECT OF THE INVENTION

The invention, as the title of the present descriptive memory states, is an infrared capture device, which makes it possible to achieve high definition. It is applicable as a complement to electronic elements, such as telephones mobile phones, thereby increasing their usefulness.

### BACKGROUND TO THE INVENTION

Some, few, mobile electronic devices, such as smartphones, incorporate cameras capable of near-infrared photography. They are often used for biometric facial recognition. These cameras are not accessible to the user in order to maintain the security of this recognition.

Therefore, users of these devices are not allowed to take pictures in conditions of reduced visibility. Moreover, it is not possible to make a 3D reconstruction of the photographed areas or objects.

The applicant is not aware of the existence of a device that solves the problems of the art in a similar way to the invention.

### DESCRIPTION OF THE INVENTION

The invention relates to an infrared capture device according to the claims. Its different variants solve the problems of the state of the art the technique.

It is a simple, inexpensive and small device that allows the capture of photographs and videos in infrared light and high definition, night vision and night vision in stereo, among other functions. It results in a camera that is detachable from the rest of the electronic device for those moments when you need it to be used.

For this purpose, the high-definition infrared capture device consists of a housing with a socket for connection to an electronic device and with one or more cameras configured to capture in the infrared. When there are two cameras, stereo image reconstruction is possible.

The housing may also comprise one or more infrared lamps and/or an infrared photometer.

Other variants are described below.

### EXPLANATION OF THE FIGURES

In order to complete the above description and to assist the better understanding of the features of the invention, this description is accompanied, as an integral part thereof, by a FIGURE in which, by way of illustration and not limitation, the following has been depicted.

FIG. 1 shows an image of the device according to an exemplary embodiment.

### PREFERRED EMBODIMENT OF THE INVENTION

The following is an example of an embodiment of the invention, which is intended for illustrative purposes only and does not limit the invention.

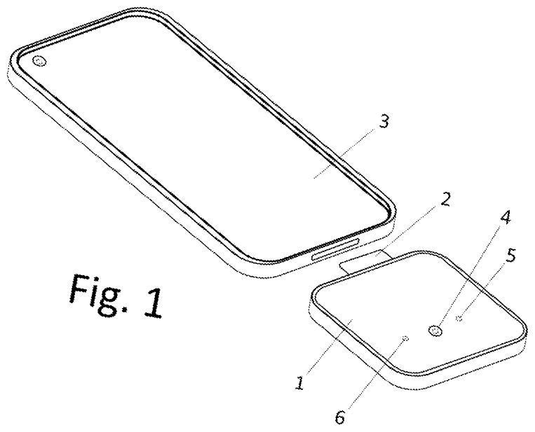

FIG. 1 shows an example of an embodiment consisting of a housing (1) with a socket (2) or connection, in this case USB type C. This socket (2) is intended to connect to a mobile phone (3), so its standard may be different, depending on the mobile phone (3), computer or tablet for which it is designed.

For example, an Apple mobile phone (3) uses a different standard than a Samsung mobile phone (3).

The housing (1) has one or more cameras (4) each with a suitable lens, as is known in the art. The cameras (4) are configured to capture in the infrared. One or more spotlights (5), preferably LEDs, are arranged next to the cameras (4), as well as a photometer (6). All elements are prepared to operate in the infrared and optionally in the visible spectrum. For example, the camera can operate in the near infrared (800-2500 nm). Other options are 300-1000 nm. Physical filters can be integrated to limit the wavelength range.

The cameras (4) shall preferably be UHD (Ultra High Definition), or ultra high definition, with autofocus. Ideally a “Time of Flight” (ToF) will be programmed to detect the time since the light takes from the focus (5) to the target. In this way, distances and 3D reconstructions can be calculated with a single camera-TOF pair or, even more robustly, with two cameras (4) and their respective ToF spotlights.

Infrared cameras (4) also allow for night vision, in two or three dimensions.

The mobile phone (3) will comprise a device management application, which commands the taking of photos or videos, receives the photos, manages its settings, etc.

1. An infrared capture device, for high or ultra high definition infrared capture, wherein the device is formed by a housing with a socket for connection to an electronic device, and with one or more cameras configured to capture in infrared.

2. The infrared capture device, according to claim 1, wherein the socket is a USB type C socket.

3. The infrared capture device, according to claim 1, wherein the housing further comprises one or more infrared lamps.

4. The infrared capture device, according to claim 1, wherein the housing further comprises an infrared photometer.

5. The infrared capture device according to claim 3, being configured to measure the time of flight of light from the spotlights.

6. The infrared capture device according to claim 5, comprising two cameras.

7. The infrared capture device according to claim 1, comprising autofocus.
